(19) United States
(12) Patent Application Publication
(10) Pub. No.: US 2005/0032231 A1
(43) Pub. Date: Feb. 10, 2005

(54) Identifying component groups with independent component analysis of chromatographicdata

(76) Inventor: Paris Smaragdis, Brookline, MA (US)

Correspondence Address: Patent Department;Mitsubishi Electric Research Laboratories, Inc., 201 Broadway, Cambridge, MA, 02139, US

(21) Appl. No.: 10/635,051

(22) Filed: Aug. 6, 2003

(51) Int. Cl. G01N 21/62

(52) U.S. Cl. 436/139; 436/171

(57) ABSTRACT

A system for analyzing a mixture of chemical components. First, a liquid or gas chromatograph produces samples of the mixture. The samples include overlapping components. A spectrometer measures wavelength of each sample. A memory stores the measured wavelengths of each sample as rows in a first matrix. Independent component analysis is applied to the first matrix to obtain a second matrix and a third matrix. Columns of the first matrix are elution profiles of distinct component groups, and rows of the third matrix are corresponding spectra of the distinct component groups.

### FIELD OF THE INVENTION

The present invention relates generally to analyzing a mixture of chemical components to identify distinct component groups, and more particularly to applying a statistical decomposition to multivariate spectrometer data.

### BACKGROUND OF THE INVENTION

The current trend in analytical systems is fast production of analytical data using gas chromatograph-magnetic sector (GC-MS) mass spectrometer systems. This makes chemometric methods for the separation of coupled chromatographic data of very high importance. Numerous approaches have been reported in the literature for the determination of composition regions and the separation of coupled chromatographic data, primarily in high-performance liquid chromatography (HPLC)-ultra violet/diode array detector (UV/DAD analysis, see Brereton et al., J. Chemom., 8, pp. 423-437, 1994, Keller et al., Anal. Chem. Acta, pp. 263, 21, 1994, and Brereton et al., Chemom. Intell. Lab. Syst., 27, pp. 73-87, 1995.

The most common methods for improving peaks separation are principal component analysis (PCA) and evolving factor analysis (EFA), especially in HPLC-UV/DAD analysis. Separation based on derivatives and spectral similarity indices have also been used, see Dunkerley et al., Chemom. Intell. Lab. Syst., 48, pp. 99-119, 1999. Each method has certain advantages and disadvantages. The selection of a particular method relies on the specific application, the available data, and the experience of the analyst.

Therefore, there is a need for a single chemometric method for separating overlapping aromatic peaks in a mixture of components, while at the same time determining an underlying spectra of the component groups.

### SUMMARY OF THE INVENTION

The method according to the invention uses independent component analysis (ICA) to concurrently separate overlapping component groups and determine underlying spectra. The method when applied to middle petroleum fractions shows an improved separation between the aromatic groups compared to the prior art methods.

The UV spectra of overlapping component groups determined by the ICA method can be further exploited to characterize the composition of the aromatic fractions.

### BRIEF DESCRIPTION OF THE INVENTION

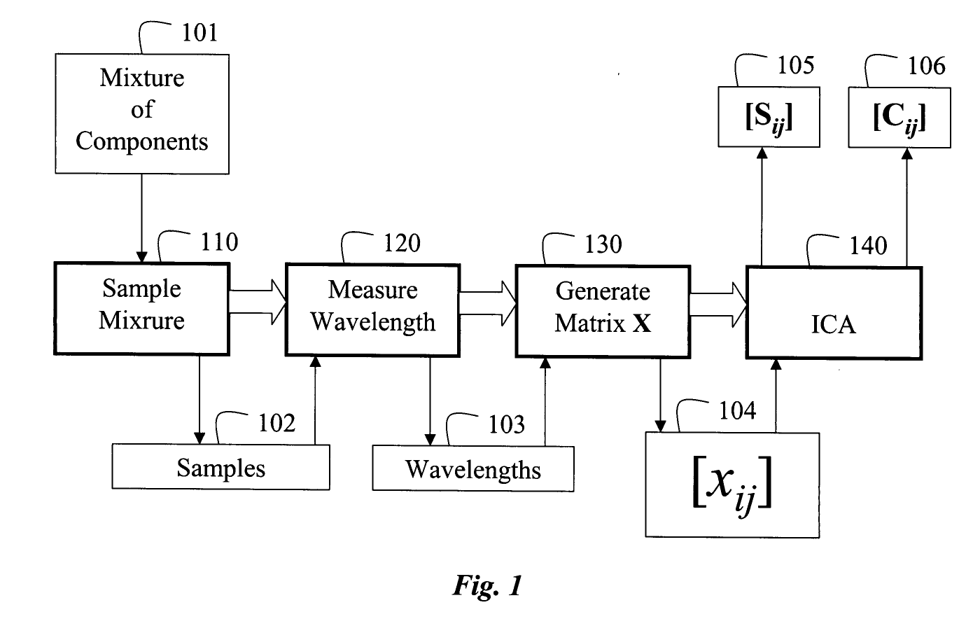

FIG. 1 is a flow diagram of a method for analyzing chromatographic data according to the invention;

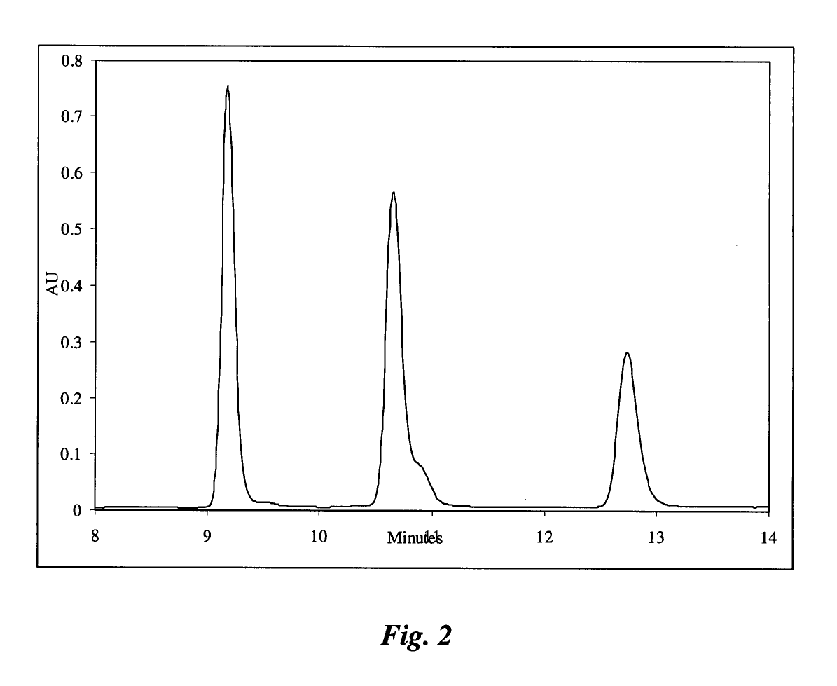

FIG. 2 is a HPLC chromatograph of a mixture of components to be analyzed according to the invention;

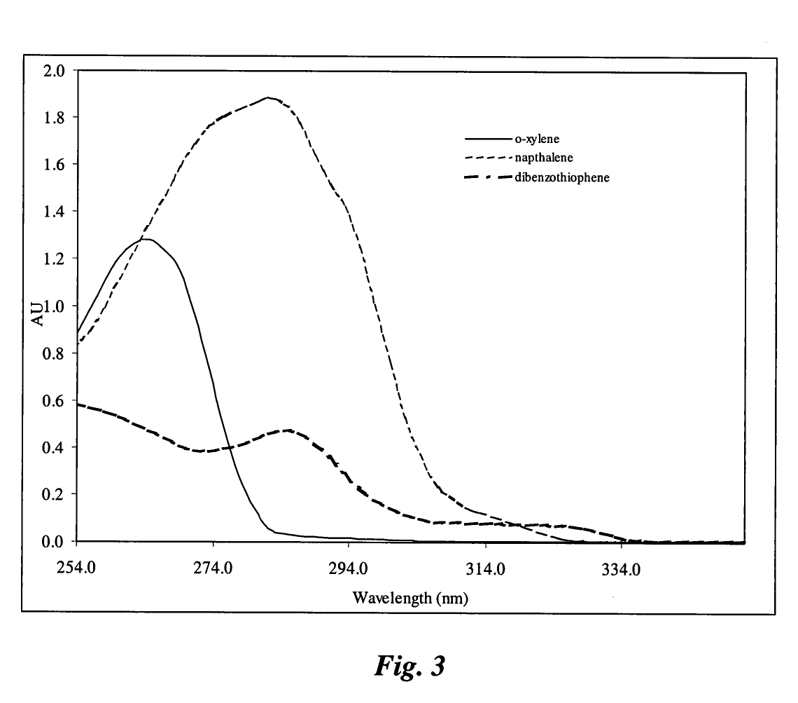

FIG. 3 is a UV spectra of the mixture of components of FIG. 2;

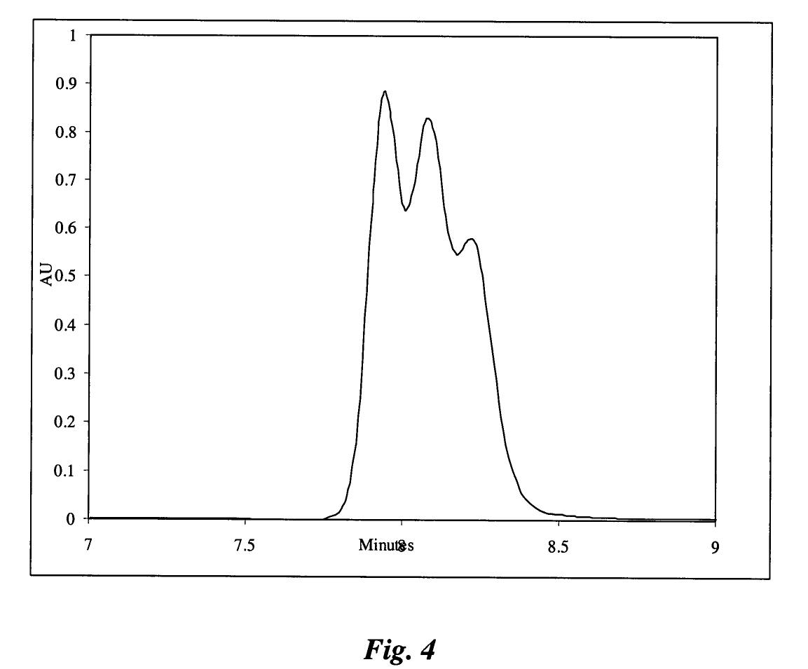

FIG. 4 is a graph of mixture analysis with overlapping components;

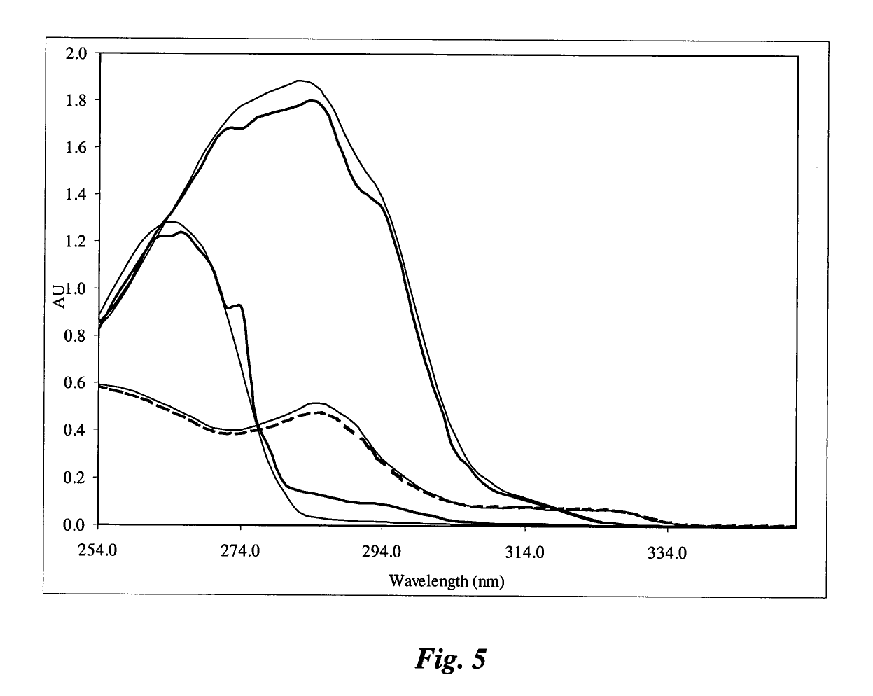

FIG. 5 is a graph of component spectra determined according to the invention;

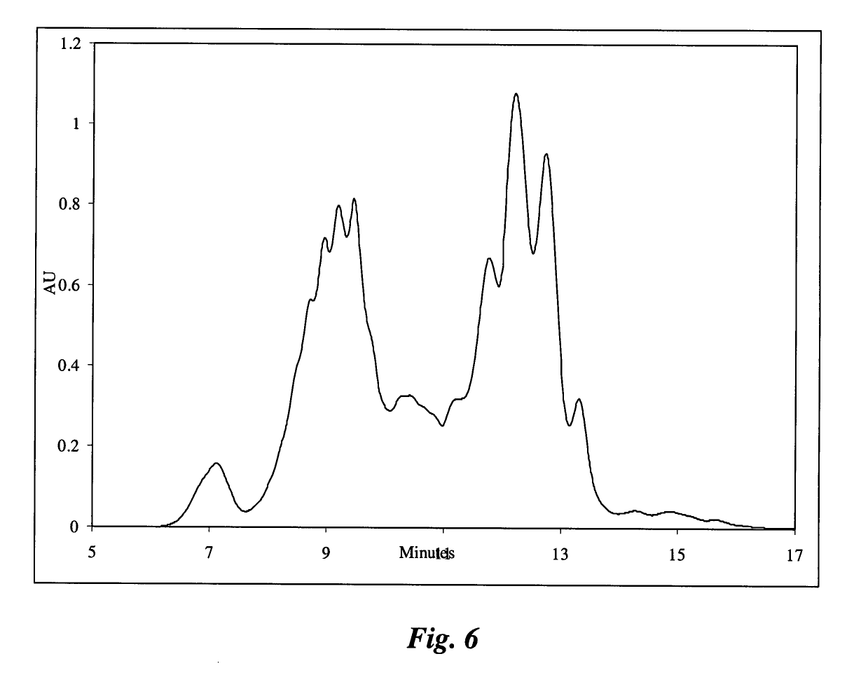

FIG. 6 is a chromatograph of a diesel fuel sample; and

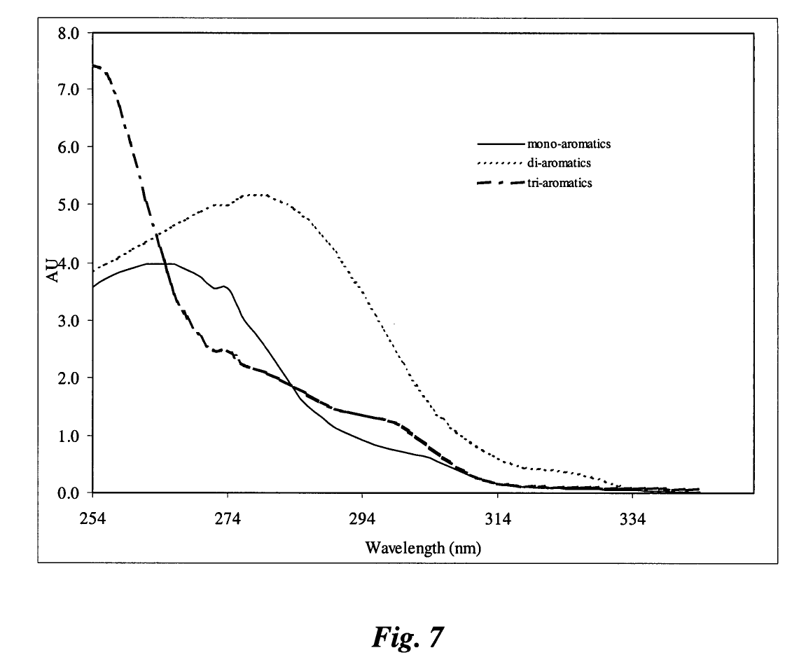

FIG. 7 is a graph of UV spectra of component groups of the diesel fuel sample determined by the invention.

### DETAILED DESCRIPTION OF THE PREFERRED EMBODIMENT

As shown in FIG. 1, the invention uses independent component analysis (ICA) for separating coupled data obtained by high performance liquid chromatography (HPLC)-ultra violet/diode array detector (UC/DAD) analysis of a mixture of chemical components 101.

The invention relies on the well-known Beer-Lambert law. Beer's law models how light intensity decreases as it passes through an absorbing solution. Beer's law is A=Ebc, where A is absorbance, E is a molar extinction coefficient, b is a pathlength in centimeters, and c is a concentration of an absorbing compound in solution.

On the basis of Beer's law, the invention formulates the problem as
X=C×S, (1)
where a matrix X=[xᵢⱼ] denotes measured spectra of an eluted mixture at an i^{th} time step, and a j^{th} wavelength, matrix C=[cᵢⱼ] denotes an elution profile of the i^{th} component group at the j^{th} time step, and S=[sᵢⱼ] denotes an intensity of the i^{th} component group at the j^{th} wavelength. The sizes of the matrices are X(n_{f}×n_{w}), C(n_{f}×nᵢ), S(nᵢ×n_{w}), where n_{f} is the number of fluid samples, i.e., time steps, n_{w} is the recorded wavelengths, and nᵢ denotes the number of components groups present in the mixture.

According to this formulation, the component groups elution profiles are stored in the columns of the matrix C, while their spectra are stored in the rows of the matrix S. Unfortunately, only the matrix X is known. It is desired to obtain the matrices C and S.

In the method according to the invention, independent component analysis (ICA) is used for blind source separation (BSS), see Hyvärinen et al. “Independent Component Analysis,” John Wiley & Sons, 2001, and Te-Won Lee; Ziehe, A.; Orglmeister, R.; Sejnowski, T., Proceedings of the 1998 IEEE International Conference on Acoustics, Speech and Signal Processing.

The ICA 140 splits the matrix X 104 is split in the two matrices C 105 and S 106 without using any additional information on the kind of the eluting components, see Hyvärinen, Neural Computing Surveys, Vol. 2, pp. 94-128, 1999.

The columns of the matrices X and S are assumed to be different instances of two non-Gaussian random vectors. The method finds the matrix S, such that the rows of the matrix S are statistically independent. That is, the components groups spectra are independent of each other.

In contrast, the prior art PCA method provides spectra, which are simply orthogonal to each other.

For the purpose of the ICA method, the continuity of time is ignored, instead each sample fraction 102 eluted 110 at each time segment is considered as a different fluid n_{f}. Therefore, the number of the fluid samples 102 is equal to the number of time steps recorded. Each fluid sample may contain one or more of the mixture components groups, depending on how the components of the mixture overlap.

Using a UV detector, each fluid sample is measured 120 at a number of wavelengths n_{w}. The larger the number of wavelengths 103 obtained by the detector, the more information is collected regarding each fluid sample.

The measured wavelength 103 generate 130 the rows of matrix X 104 stored in a memory. ICA is applied 140 to the matrix X 104 to obtain the matrices S 105 and C 106. The spectra 103 of each fluid sample can be considered as a different signal, which following the notation of equation (1) is a linear combination of the signals contained in the rows of the matrix S matrix 105, i.e., the spectra of the components groups present in the mixture.

The idea behind the method according to the invention is that even if the spectra of any subset of the groups is known, there is still no information for the remaining unknown spectra because the unknown spectra contains entirely different components. This idea essentially expresses a statistical independence in the data.

The statistical independence produced by the ICA method is a much stronger requirement than uncorrelatedness provided by the prior art PCA method, which simply implies orthogonality of the groups spectra. With the prior art PCA method, information of a group's spectra is still hidden in the spectra of other samples.

Independence requires that statistics of order higher than two are also equal to zero. The ICA method uses information on the distribution of the required spectra, which is not contained in the covariance matrix.

The ICA method for separating overlapping 3-D chromatographic data can be applied to data derived from HPLC-DAD analysis of a synthetic mixture containing three aromatic components, namely o-xylene, naphthalene and dibenzothiophene, respectively 90:9:1% by weight. In a mobile phase, a mixture of n-hexane and isopropyl ether, 95:5 by volume is used. The chromatogram at 254 nm and the UV spectra acquired with a spectometer at the peak maximum for each one of the mixture components are shown in FIGS. 2 and 3. In order to acquire UV-DAD data exhibiting strong overlapping between the peaks, the mobile phase composition is changed to n-hexane and isopropyl ether (25:75 v:v). The selection is based on a relationship that exists between the resolution and the mobile phase composition.

The derived chromatogram under the new conditions chromatogram for the mixture of o-xylene, naphthalene and dibenzothiophene (90:9:1% w.) at 254 nm is shown in FIG. 4, where a strong overlapping between the three components can be seen.

The matrix X for the ICA method is generated 130 contructed using Millenium chromatography software from Waters Associates, Milfred, Mass. U.S.A. The chromatographic signals derived for all the odd wavelengths between 254 and 352 nm are integrated and areas under the signal for time slices of 0.05 minutes are determined. The 21×50 matrix X contains in its rows the “spectra” over the range 254-352 nm that correspond to the fractional sample of the mixture eluted within each time slice. The columns of the matrix X respectivelly represent the elution profiles of the whole mixture at each wavelength.

The ICA analysis was performed using the JADE algorithm, see Cardoso et al., IEEE Proceedings F, 140(6), pp. 362-370, 1993.

The eigenvalues of the matrix X indicate the presense of three main features (spectra) as expected. Therefore, three independent components (matrix S) are determined, which are illustrated in FIG. 5 together with the derived spectra of pure components. Note that the spectra of independent components have been brought to the same scale as the spectra of the pure components for comparison purposes.

Visual comparison of the two sets shows that there is an excelent match between the the spectra calculated by the ICA and the spectra of pure components. The calculated correlation coefficients for each pair of spectra are 0.996 and 0.999, respectively. The elution profiles (matrix C) are calculated from equation (1), resulting in an excellent separation of the components peaks.

The ICA method is also applied to the HPLC UV-DAD analysis of a diesel sample for the determination of the existing component groups. The chromatographic analysis is carried out using an optimized procedure described by Pasadakis et al., Proceedings of International Conference Instrumental Methods of Analysis IMA, Vol II, pp. 472-476, 2001. The chromatogram at 254 nm is shown in FIG. 6. The 3-D UV-DAD signal is now represented by a 25×50 data matrix with the time step of the integration set at 0.4 minutes. The eigenvalues plot of this data matrix indicated three significant patterns within the data and the ICA method determines the corresponding spectra features as shown in FIG. 7, which are attributed to the mono-, di- and tri-aromatic components of the diesel. As expected, the calculated by the ICA elution profiles that correspond to the aromatic groups excibit significant overlapping.

Effect of the Invention

A new multivariate analysis method, the ICA, is applied for the interpretation of the HPLC-UV-DAD data of hydrocarbon mixtures. The method improves significantly the separation in the analysis of synthetic mixtures, by providing very accurate estimation of the underlying spectra. The method can be also applied for identifying component groups in complex hydrocarbon mixtures.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for analyzing a mixture of chemical components, comprising:
obtaining a plurality of samples of the mixture, in which the samples include overlapping components;
measuring a plurality of wavelength of each sample of overlapping components;
storing the measured wavelengths of each sample as rows in a first matrix; and
applying independent component analysis to the first matrix to obtain a second matrix and a third matrix, in which columns of the first matrix are elution profiles of distinct component groups and rows of the third matrix are corresponding spectra of the distinct component groups.

2. The method of claim 1, in which the samples are obtained by chromatography, and the wavelengths are measured by spectography.

3. The method of claim 1, in which the mixture includes aromatic components.

4. The method of claim 1, in which the mixture is a diesel fuel.

5. A system for analyzing a mixture of chemical components, comprising:
a chromatograph produces a plurality of samples of the mixture, in which the samples include overlapping components;
a spectrometer measures a plurality of wavelength of each sample of overlapping components;
a memory stores the measured wavelengths of each sample as rows in a first matrix; and
means for applying independent component analysis to the first matrix to obtain a second matrix and a third matrix, in which columns of the first matrix are elution profiles of distinct component groups and rows of the third matrix are corresponding spectra of the distinct component groups.
